(19) United States
(12) Patent Application Publication
(10) Pub. No.: US 2006/0065360 A1
(43) Pub. Date: Mar. 30, 2006

(54) Method for fixing a logo label to an upper of an article of footwear

(76) Inventor: Kun-Chung Liu, Taichung Hsien (TW)

Correspondence Address: FOLEY AND LARDNER LLP;SUITE 500, 3000 K STREET NW, WASHINGTON, DC, 20007, US

(21) Appl. No.: 10/952,125

(22) Filed: Sep. 29, 2004

(51) Int. Cl. B32B 37/00

(52) U.S. Cl. 156/272.8

(57) ABSTRACT

A method for fixing a logo label to an upper of an article of footwear is provided. The upper has a protective skin formed thereon. The method includes the steps of: (a) forming a cavity in the protective skin of the upper by using a laser beam; (b) filling the cavity in the protective skin with an adhesive; and (c) adhering the logo label to the upper through the adhesive in the cavity in the protective skin.

### BACKGROUND OF THE INVENTION

1. Field of the Invention

This invention relates to a method for fixing a logo label to an article, more particularly to a method for fixing a logo label to an upper of an article of footwear.

2. Description of the Related Art

Generally, an article of footwear bears a logo label on an upper thereof for showing a trademark or for ornamentation purposes. The upper of the article of footwear is normally coated with a protective skin. Since this protective skin is smooth, the logo label, such as logo labels made from plastic, rubber or cloth materials, is difficult to be adhered to the upper of the article of footwear through an adhesive, and is normally attached to the upper through stitching techniques, which is laborious and time-consuming.

### SUMMARY OF THE INVENTION

Therefore, the object of the present invention is to provide a method for fixing a logo label to an upper of an article of footwear that is clear of the aforesaid drawback of the prior art.

According to this invention, there is provided a method for fixing a logo label to an upper of an article of footwear. The upper has a protective skin formed thereon. The method includes the steps of: (a) forming a cavity in the protective skin of the upper by using a laser beam; (b) filling the cavity in the protective skin with an adhesive; and (c) adhering the logo label to the upper through the adhesive in the cavity in the protective skin.

### BRIEF DESCRIPTION OF THE DRAWINGS

Other features and advantages of the present invention will become apparent in the following detailed description of the preferred embodiment of this invention, with reference to the accompanying drawings, in which:

FIG. 1 is a flow diagram to illustrate consecutive steps of the preferred embodiment of a method for fixing a logo label to an upper of an article of footwear according to this invention;

FIG. 2 is a schematic view to illustrate preparation of a logo label and an upper of an article of footwear used in the method according to this invention;

FIG. 3 is a schematic view to illustrate how a cavity in a protective skin of the upper is formed by using a laser beam;

FIG. 4 is a schematic view to illustrate the step of filling the cavity in the protective skin with an adhesive; and

FIG. 5 is a schematic view to illustrate consecutive steps of removing the cover layer from the protective skin and subsequently adhering the logo label to the upper of the article.

### DETAILED DESCRIPTION OF THE PREFERRED EMBODIMENT(S)

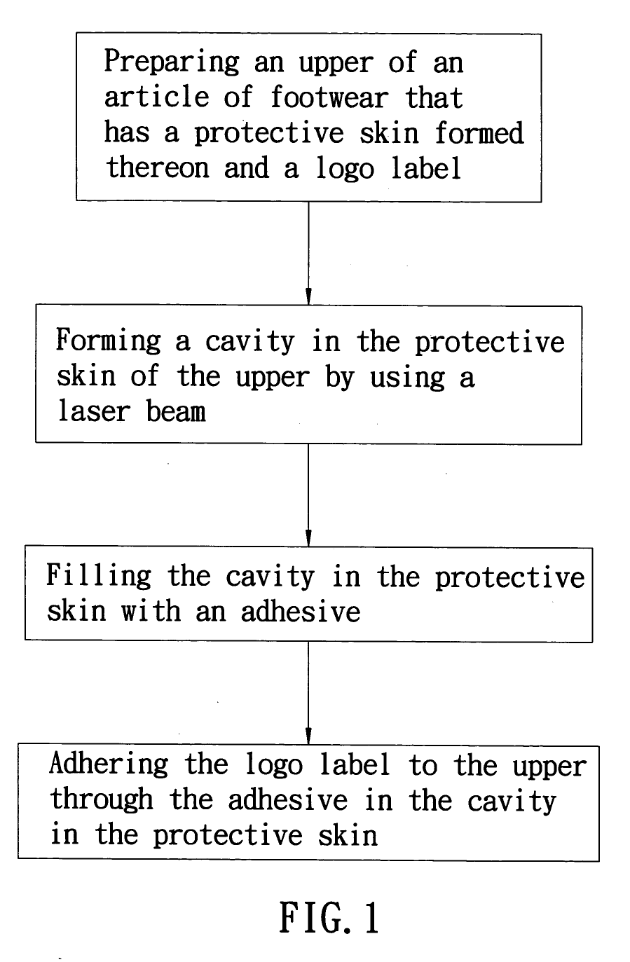

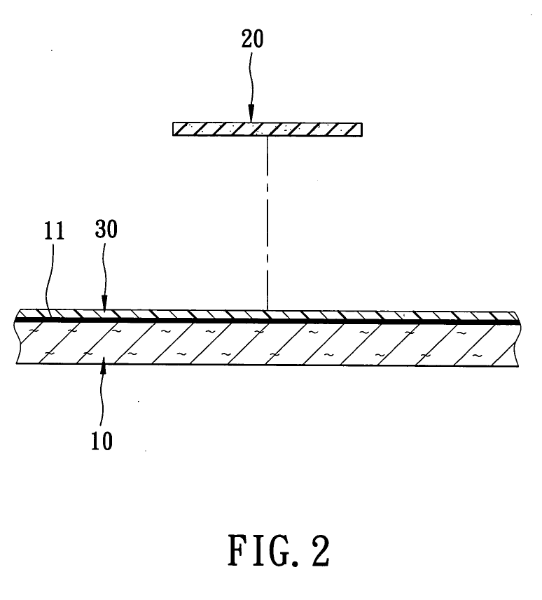

Referring to FIGS. 1 and 2, the preferred embodiment of a method for fixing a logo label to an upper of an article of footwear involves preparation of a logo label 20 and an upper 10 of an article of footwear. The upper 10 of the article of footwear is coated with a protective skin 11 that can be colored. In this preferred embodiment, the protective skin 11 is preferably coated with a releasable cover layer 30.

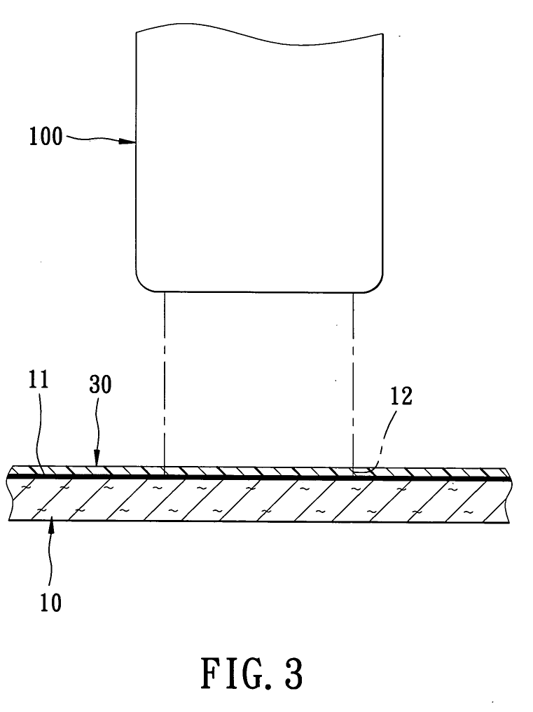

Referring to FIGS. 1 and 3, a portion of the releasable cover layer 30 and a portion of the protective skin 11 coated on the upper 10 of the article of footwear are removed by a laser beam from a laser device 100, so as to form a cavity 12 in the protective skin 11 and a hole in the cover layer 30. The hole in the cover layer 30 is registered with and conforms to the cavity 12 in the protective skin 11. The laser device 100 may be a laser engraving machine. The frequency, current, power, moving speed and trace of light spots of the laser beam can be adjusted so as to form the hole in the cover layer 30 and the cavity 12 in the protective skin 11 that have a desired shape corresponding to that of the logo label.

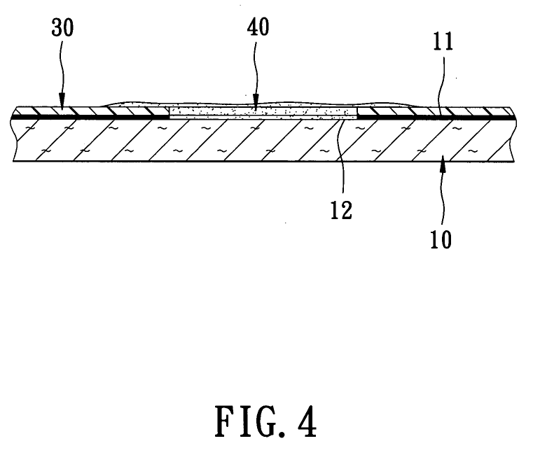

As shown in FIGS. 1 and 4, before removal of the cover layer 30, an adhesive 40 is filled in the hole in the cover layer 30 and the cavity 12 in the protective skin 12.

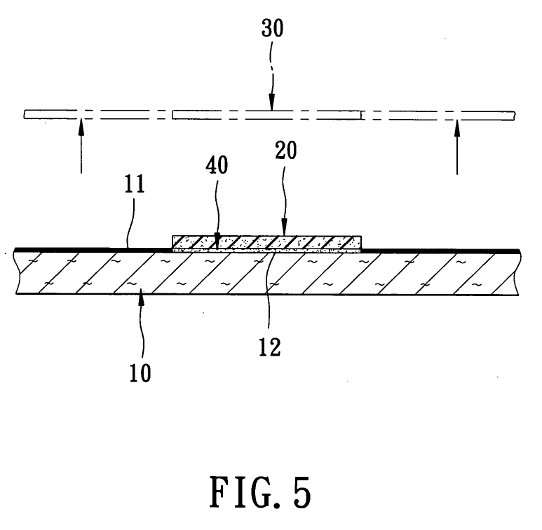

As shown in FIGS. 1 and 5, the cover layer 30 is removed from the protective skin 11, and the logo label 20 is adhered to the upper 10 of the article of footwear through the adhesive 40 in the cavity 12 in the protective skin 11.

With the cover layer 30 attached to the protective skin 11, filling operation of the adhesive 40 as shown in FIG. 4 is facilitated, and undesired application of the adhesive 40 to a periphery of the cavity 12 or the upper 10 is prevented.

As compared to the stitching operation in the conventional method, the use of the laser device 100 and the adhesive 40 in this invention simplifies the method for fixing the logo label to the upper of the article of footwear and thus, the cost of the method can be decreased.

While the present invention has been described in connection with what is considered the most practical and preferred embodiments, it is understood that this invention is not limited to the disclosed embodiments but is intended to cover various arrangements included within the spirit and scope of the broadest interpretations and equivalent arrangements.

What is claimed is:

1. A method for fixing a logo label to an upper of an article of footwear, the upper having a protective skin formed thereon, the method comprising the steps of:
(a) forming a cavity in the protective skin of the upper by using a laser beam;
(b) filling the cavity in the protective skin with an adhesive; and
(c) adhering the logo label to the upper through the adhesive in the cavity in the protective skin.

2. The method of claim 1, further comprising attaching a releasable cover layer to the protective skin prior to the formation of the cavity in the protective skin, the cover layer being formed with a hole by the laser beam during step (a), the hole in the cover layer being registered with and conforming to the cavity in the protective skin so as to prevent undesired application of the adhesive to a periphery of the cavity during step (b).
